(19) United States
(12) Patent Application Publication
(10) Pub. No.: US 2005/0283602 A1
(43) Pub. Date: Dec. 22, 2005

(54) Apparatus and method for protected execution of graphics applications

(76) Inventors: Balaji Vembu, Folsom, CA (US); Clifford D. Hall, Orangevale, CA (US); Aditya Sreenivas, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/873,803

(22) Filed: Jun. 21, 2004

(51) Int. Cl. H04L 9/00

(52) U.S. Cl. 713/150

(57) ABSTRACT

A method and apparatus for protected execution of graphics are described. In one embodiment, the method includes the formation of a translation table for a trusted application. In one embodiment, the translation table is formed according to one or more protected pages assigned to the trusted application in response to a protected page request from the trusted application. During execution of the trusted application, a virtual address space of the trusted application is translated to the one or more protected pages assigned to the trusted application. In one embodiment, the translation is performed according to the translation table assigned to the trusted application. Accordingly, by assigning a unique translation table to each trusted application, the various trusted applications may execute within the platform without generating an access into another application's physical address space. Other embodiments are described and claimed.

### FIELD OF THE INVENTION

One or more embodiments of the invention relate generally to the field of protected execution. More particularly, one or more of the embodiments of the invention relates to a method and apparatus for execution of graphics application.

### BACKGROUND OF THE INVENTION

Today's personal computer (PC) is typically linked to the Internet or Intranet and is widely used for creation, storage, editing and sharing of personal, corporate/government information. This enables the PC to play a critical role in a PC user's ability to conduct business, collaborate, access confidential data and conduct electronic transactions with third parties. A key reason for the widespread use of current PCs is the open nature of PC platforms. The architecture's interfaces are well-documented and understood, allowing for a variety of powerful software and hardware capabilities that deliver value to corporations and end users.

The proliferation of the Internet has led to the creation of a new form of commerce, generally referred to as Internet or electronic commerce (E-commerce). E-commerce has led to the availability of media applications, playback of motion pictures, music and other like entertainment, which may be downloaded to a PC for one-time use or for use for a predetermined period of time. Such media applications may send display information to a graphics frame buffer, which is read by a display engine. The display engine combines a converted set of source images or surfaces within the frame buffer and delivers the information to an output interface connected eventually to a display device. Such media applications are referred to herein as “graphics applications”.

Conventionally, graphics applications may require a rendering engine to draw pixels to be displayed into the frame buffer, which is read out by the display engine and routed to a display. Conventionally, a render engine and display engine may be implemented within a graphics adapter or a graphics controller. In operation, such graphics applications may request allocation of a portion of main memory for the graphic adapter's use. Generally, such graphics applications issue a call to the operating system (OS), which manages main memory.

As an example, a graphics driver may request a 16 megabyte (MB) block of main memory. This presents a problem for the OS, which may manage main memory in blocks of 4 kilobytes (KB), referred to as “pages”. Accordingly, rather than allocate a continuous segment of main memory, in response to a request for a large block of memory, the OS locates a required number of memory pages that are not currently in use from, for example, a free memory pool (e.g., a request for 16 MB of memory requires 4096 pages). This memory management technique of simulating a large address space with a small amount of physical memory is generally referred to as “page demanded virtual memory”.

In response to the request, the OS returns a 32-bit linear memory start address above the top of main memory to the graphics application and sets up a series of page table entries that translate accesses within the example 16 MB linear address range (“virtual memory”) to the appropriate pages of main memory. Accordingly, whenever graphics application, while executing on the processor, attempts to access the assigned virtual memory, the processor paging mechanism automatically performs the required address translation from linear to graphics address. Software builds a translation table in memory for the graphics address to physical address translation and informs the graphics adapter of the base address of the translation table in memory. For example, for accelerated graphics port (AGP) adapters, a graphics address reallocation table (GART) is provided.

Unfortunately, the GART shared among the graphics application is accessible by a rogue agent and may be used to read physical memory pages used by a media application to duplicate media content, such as a motion picture. Hence, without some mechanism for protecting the content provided by such media applications from access by rogue agents, E-commerce involving such media applications may be prohibitive to the media providers. As a result, media or content providers may be reluctant to create high quality media or content providing applications since such content may be susceptible to rogue agents.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system to provide protected execution of graphics applications, in accordance with one embodiment.

FIG. 2 is a block diagram further illustrating the graphics memory controller hub of FIG. 1, in accordance with one embodiment.

FIG. 3 is a block diagram illustrating system memory remapping according to a trusted graphics translation table, in accordance with one embodiment.

FIG. 4 is a block diagram illustrating protected execution of command buffer instructions, in accordance with one embodiment.

FIG. 5 is a block diagram further illustrating the command buffer of FIG. 4, in accordance with one embodiment.

FIG. 6 is a flowchart illustrating a method for assigning a trusted graphics translation table to a trusted graphics application, in accordance with one embodiment.

FIG. 7 is a flowchart illustrating a method for mapping virtual addresses referenced by command buffer instructions to protected physical address according to a graphics translation table assigned to a trusted application, in accordance with one embodiment.

FIG. 8 is a flowchart illustrating a method of allocating one or more protected pages to a trusted graphics application, in accordance with one embodiment.

FIG. 9 is a flowchart illustrating a method for generating a command buffer, in accordance with one embodiment.

FIG. 10 is a flowchart illustrating a method for verifying completion of a prior command buffer prior to installation of a current command buffer, in accordance with one embodiment.

FIG. 11 is a block diagram illustrating various design representations or formats for simulation, emulation and fabrication of a design using the disclosed techniques.

### DETAILED DESCRIPTION

In the following description, numerous specific details such as logic implementations, sizes and names of signals and buses, types and interrelationships of system components, and logic partitioning/integration choices are set forth to provide a more thorough understanding. It will be appreciated, however, by one skilled in the art that the invention may be practiced without such specific details. In other instances, control structures and gate level circuits have not been shown in detail in order not to obscure the invention. Those of ordinary skill in the art, with the included descriptions, will be able to implement appropriate logic circuits without undue experimentation.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logical. The integrated circuit may take the form of a processor such as a microprocessor, application specific integrated circuit, a digital signal processor, a micro-controller, or the like.

An example of “software” includes executable code in the form of an application, an applet, a routine or even a series of instructions. In one embodiment, an article of manufacture may include a machine or computer-readable medium having software stored thereon, which may be used to program a computer (or other electronic devices) to perform a process according to one embodiment. The computer or machine readable medium includes but is not limited to: a programmable electronic circuit, a semiconductor memory device inclusive of volatile memory (e.g., random access memory, etc.) and/or non-volatile memory (e.g., any type of read-only memory “ROM”, flash memory), a floppy diskette, an optical disk (e.g., compact disk or digital video disk “DVD”), a hard drive disk, tape, or the like.

System

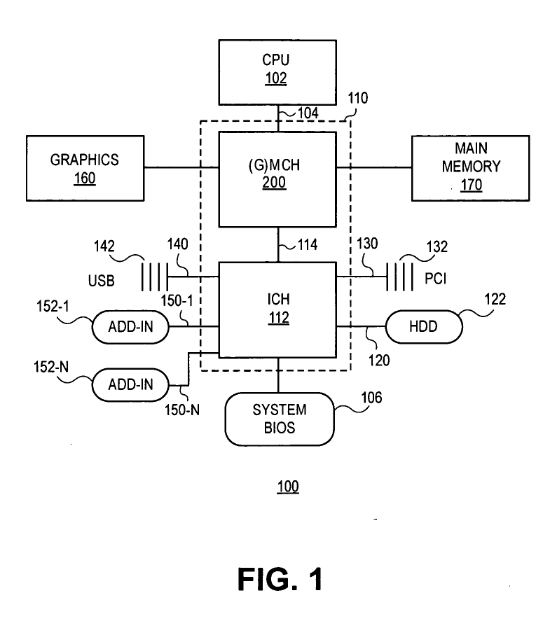

FIG. 1 is a block diagram illustrating computer system 100 to provide protected execution of trusted graphics applications, in accordance with one embodiment. Representatively, computer system 100 comprises a processor system bus (front side bus (FSB)) 104 for communicating information between processor (CPU) 102 and chipset 110. As described herein, the term “chipset” is used in a manner to collectively describe the various devices coupled to CPU 102 to perform desired system functionality.

Representatively, chipset 110 may include integrated graphics memory controller hub (GMCH) 200. In an alternative embodiment, a graphics controller is separate from a memory controller and may be implemented within graphics block 160, such that graphics block 160 is, in one embodiment, a graphics chipset coupled to MCH 200. Representatively, GMCH 200 is coupled to main memory 170. In one embodiment, main memory 170 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

As further illustrated, chipset 110 includes an input/output (I/O) controller hub (ICH) 112. Representatively, ICH 112 may include a universal serial bus (USB) link or interconnect 140 to couple one or more USB slots 142 to ICH 112. In addition, a peripheral component interconnect (PCI) bus 130 may couple one or more PCI slots 132 to ICH 112. Likewise, a serial advance technology attachment (SATA)120 may couple hard disk drive devices (HDD) 122 to ICH 112. Likewise, ICH 112 may include PCI-Express links 150 (150-1, . . . 150-N) to couple add-in cards 152 (152-1, . . . , 152-N) to ICH 112. In one embodiment, system BIOS 106 initializes computer system 100.

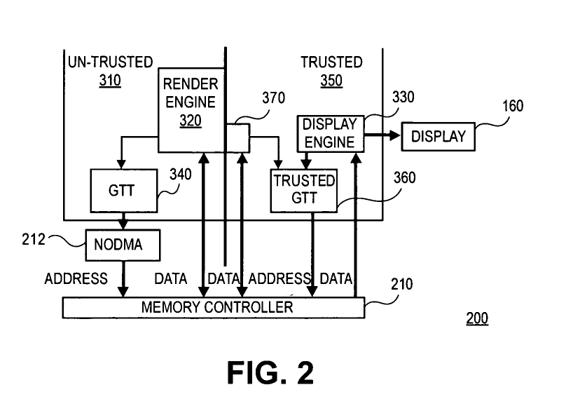

As illustrated in FIG. 2, in one embodiment, GMCH 200 is partitioned into an untrusted portion 310 and a trusted portion 350. Representatively, untrusted portion 310 includes graphics translation table (GTT) 340. In one embodiment, GTT 340 enables GMCH 200 to provide virtual memory to graphics applications. Hence, GTT 340 provides scatter/gather capabilities for assigned graphics memory. In one embodiment, GTT 340 is a single level address remapper of a virtual address space assigned to graphics applications to a physical address space within pages of system memory 170 In one embodiment, GTT entries are programmed by a graphics driver. Unfortunately, since GTT 340 is shared by each graphics application, the various graphics applications may freely access other graphics application's address space.

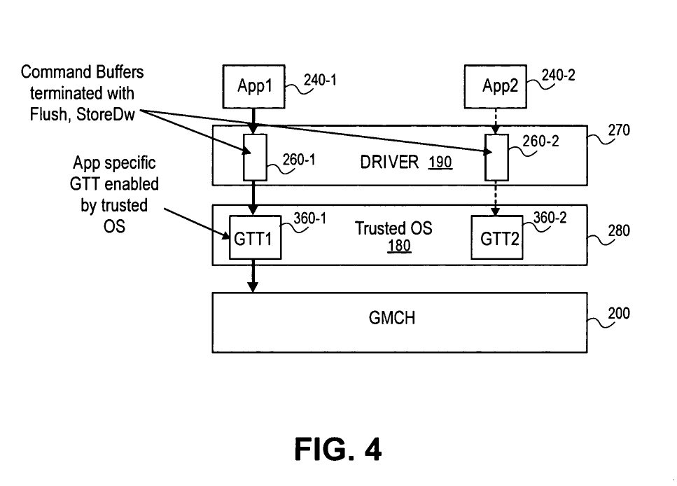

In other words, the use of a single GTT prohibits protected execution of trusted graphics applications. As described herein, protected execution provides applications with the ability to run in an isolated, protected execution environment. Hence, unauthorized software on the platform is unable to observe or compromise information being operated on within a protected execution environment, such as, for example, illustrated with reference to FIG. 4.

As described herein, a trusted application, such as a trusted graphics application, refers to a specially protected (trusted) software module that may be used, for example, to perform specific sensitive activities, possibly in the presence of hostile software. Accordingly, in one embodiment, a trusted application, or trusted software, may refer to tamper-resistant software or an application which has been authenticated and attested by a trusted portion of the operation system (trusted OS). In one embodiment, a secure virtual machine monitor (SVMM) authenticates and attests that a graphics application is a trusted graphics application when launch of such an application is detected.

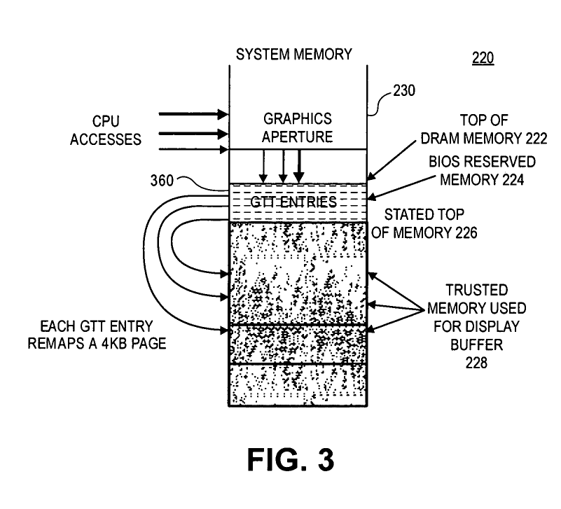

Accordingly, in one embodiment, GMCH 200 is configured to provide a secure protected execution environment for trusted graphics applications. In one embodiment, GMCH 200 provides address space isolation of the address space assigned to trusted graphics application so that a graphics application cannot generate an access into a trusted graphics application address space. In one embodiment, untrusted graphics applications use GTT 340 and trusted applications use trusted GTT 360. In one embodiment, trusted applications store their data in protected pages, for example, as illustrated with reference to FIG. 3.

TABLE 1

| Address | Name | Access | Description |
|---|---|---|---|
| 0510 | TGABAR | Read/Write | Trusted Graphics Aperture Base |
| | | | Address Register |
| | | | 256 MB, Size aligned |
| | | | mapped into DRAM |
| 0514 | TGRBAR | Read/Write | Trusted Graphics Register Base |
| | | | Address Register |
| | | | Register location |
| | | | 512k total space, Size aligned |
| | | | mapped to internal chipset |
| | | | registers, not DRAM |
| 0518 | TGGTT | Read/Write | Trusted Graphics - Graphics |
| | | | Translation Table (Read/Write) |
| | | | 1 M, Base aligned to a 1 M boundary |
| | | | points to physical memory |
| | | | Trusted GTT will reside in |
| | | | the lower 256 KB |
| | | | Rest of the space used as |
| | | | trusted graphics scratchpad |

FIG. 3 illustrates a block diagram illustrating a partition 220 of system memory 170, in accordance with one embodiment. Representatively, an address space may be assigned to graphics applications, which is placed at the top of system memory 170 and is referred to herein as graphics aperture 230. In one embodiment, at power-on, system BIOS 106 (FIG. 1) allocates up to 256 megabytes (MB) of contiguous address space above top of memory 170 for trusted graphics aperture 230 and will write the location of the allocated memory into a trusted graphics application base address register (TGABAR), as illustrated in Table 1.

In one embodiment, system BIOS 106 allocates a 512 KB range above top of the memory 220 for the registers and writes the location to the TGRBAR register. Subsequently, system BIOS 106 steals another 1 MB of memory below the top of memory 222 and writes the location to trusted graphics graphics translation table (TGGTT) register. Trusted GTT 360 starts at offset zero and is 256 KB in size. In one embodiment, trusted GTT 360 handles translation of access into graphics aperture 230 to trusted physical addresses to further ensure protected execution of such trusted graphics applications. In one embodiment, memory pages that are assigned to trusted graphics applications, referred to herein as “protected pages”, are protected from non-CPU access.

As described herein, non-CPU access refers to direct memory access (DMA) by devices. In other words, rather than request that CPU 102 perform a memory access to provide requested data, the device directly accesses memory 170 via GMCH 200 (see FIG. 1). Accordingly, in one embodiment, protected pages assigned to a trusted application are referenced within no-DMA table 212 to prohibit direct memory access to such pages. In one embodiment, GMCH 200 blocks all non-CPU access to protected pages by first checking any access against no-DMA table 212.

In one embodiment, trusted GTT 360 is maintained by the certified and secure, trusted OS. In one embodiment, each trusted GTT assigned to a respective trusted graphics application is stored within protected storage by GMCH 200. Accordingly, in one embodiment, after allocating a protected page, the trusted OS is responsible for updating the no-DMA table 212 to block DMA access to the assigned protected page. In one embodiment, untrusted applications share GTT 340. Hence, untrusted applications are not provided with address space isolation. As a result, sharing of GTT 340 between untrusted graphics applications enables one trusted graphics application to access another graphics application's address space, thus prohibiting protected execution.

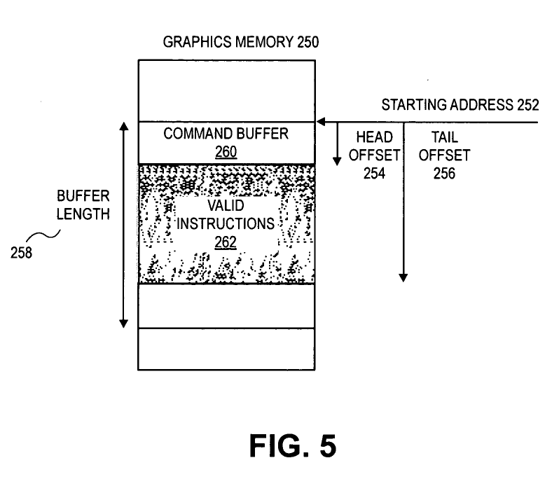

Accordingly, in one embodiment, GMCH 200 is configured to assign each trusted graphics application its own unique, trusted GTT. In one embodiment, the trusted OS is responsible for creating each trusted GTT and ensuring that each trusted GTT does not have any pages that overlap with any other application's trusted GTT. Hence, graphics applications are prohibited from generating an access that falls outside their assigned physical address space. In one embodiment, GTT allocation and edits are managed by the trusted OS to ensure that the GTT address space isolation property is not violated. In one embodiment, before an application starts executing, the trusted OS loads the appropriate GTT into GMCH 200, for example as shown in FIG. 5.

As illustrated in FIG. 4, trusted OS 180 operates within protected execution environment 280, which may be referred to herein as “ring-zero”. In one embodiment, computer system 100 operates according to four privilege levels: (1) level zero, which is the highest privilege level; (2) level one; (3) level two; and (4) level three, which is the lowest privilege level. Accordingly, the OS of computer system 280 limits access to protected execution environment 280 to entities having the highest privilege level or level zero privilege level, such as, for example, trusted OS 180. As further illustrated in FIG. 4, execution environment 270 is limited to entities having a level three privilege level and may be referred to herein as “ring-three”.

Accordingly, as illustrated in FIG. 4, application 240-1 is executed and may request rendering of application programming interface (API) commands, which are sent to an independent hardware vendor (IVH) supplied graphics driver 190 residing, for example, within ring-three execution environment 270. In one embodiment, driver 190 translates the API commands into GMCH graphics commands. In one embodiment, application 240-1 is a trusted application and is assigned its own trusted GTT 360-1. Accordingly, by assigning each graphics application (trusted/untrusted) its own GTT (trusted/untrusted), each application is given its own virtual address space.

In one embodiment, a virtual address space of, for example, 128 MB is assigned to each application. Representatively, driver 190 generates all surface addresses in this virtual address space to form a command buffer. Accordingly, as illustrated with reference to FIG. 4, the trusted OS is responsible for installing GTT 360-1 of application 240-1 prior to execution of, for example, command buffer 260-1 written by driver 190. In one embodiment, command buffer 260-1 is used to submit rendering instructions to render engine 370 (FIG. 2), which writes out pixels to a frame buffer within a protected portion of memory 170 (FIG. 1). Subsequently, display engine 330 reads these pixels and routes the pixels to display 160, as shown in FIG. 2.

TABLE 2

| Address | | 0x2030 |
|---|---|---|
| Bit(s) | Name | Description |

Ring Tail

| | | |
|---|---|---|
| 20-3 | Tail Offset | Address of last Oword past the last |
| | | valid instruction |

Ring Head

| | | |
|---|---|---|
| 20-2 | Head Offset | Indicates offset of next Dword to |
| | | be parsed. |

Ring Start

| | | |
|---|---|---|
| 31-12 | Ring Start Address | Start Address of the ring (4K aligned) |

Ring Ctl

| | | |
|---|---|---|
| 20-12 | Buffer Length | Specifies length of ring buffer in |
| | | terms of 4K pages |
| 0 | Ring Buffer Enable | Used to Enable/Disable a ring |

In one embodiment, driver 190 is responsible for generating command buffer 260. As illustrated in FIG. 5, graphics memory 250 includes command buffer 260, which has an associated head offset 254 and tail offset 256, as well as a buffer length 258. In one embodiment, command buffers are defined according to a set of command buffer registers and a memory area that is used to hold the actual instructions 262. In one embodiment, the command buffer registers, for example as illustrated in Table 2, define the start (Ring Start) and length (Ring Ctl) of the memory area assigned for the command buffer and include head and tail pointers 254 and 256 into the memory area.

In one embodiment, software uses the tail offset 256 to inform an instruction parser (IP) of the presence of valid instructions that require execution. Representatively, head offset 250 is incremented by the IP as those instructions are parsed and executed. Accordingly, as the head offset is incremented during execution of each of the instructions contained within command buffer, head offset 254 will eventually match tail offset 256 once execution of instructions 262 is complete. In one embodiment, command buffer 260 is terminated by inserting a pipeline flush command and a store double word (dword) command.

Accordingly, in one embodiment, prior to activating a new command buffer 260-1 and inserting GTT 360-1 associated with command buffer 260-1, trusted OS 190 waits for the store command of previously executing command buffer 260-2 to take affect. In one embodiment, the trusted OS then verifies that previous command buffer 260-2 has completed execution by reading the command buffer head offset 254 and tail offset 256 to verify that the offsets match. Accordingly, in one embodiment, when both the store command and head and tail equality have been verified, the trusted OS places the GTT 360-1 within ring-zero execution environment 280 and then programs command buffer registers (see Table 2) to activate the new command buffer. Procedural methods for implementing one or more embodiments are now described.

Operation

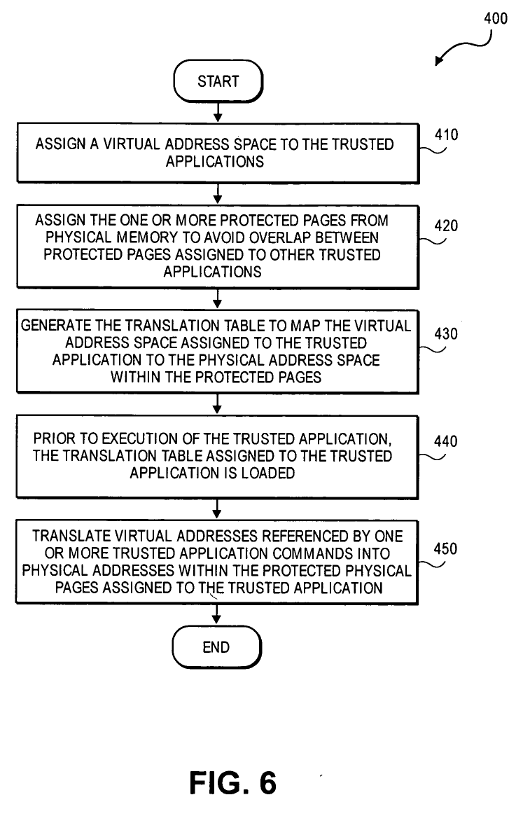

FIG. 6 is a flowchart illustrating a method 400 for protected execution of a trusted graphics application, in accordance with one embodiment. At process block 410, a virtual address space is assigned to a trusted application, as verified by, for example, a secure portion of operating system code, referred to herein as the “trusted OS”. Once assigned, at process block 420, one or more protected pages from physical memory are assigned to the trusted application to avoid overlap between protected pages assigned to other trusted applications.

In other words, in one embodiment, the trusted OS is responsible for creating each unique GTT assigned to an application and ensuring that the GTT does not have any pages that overlap with any other protected pages assigned to any other application's GTT. At process block 430, a translation table is generated to map the virtual address space assigned to the trusted application to a physical address space within the protected pages assigned to the trusted application. At process block 440, prior to execution of the trusted application, the translation table or trusted GTT assigned to the trusted application is loaded within a secure (protected) execution environment.

For example, as illustrated in FIG. 4, ring-three execution environment 270 is illustrated wherein an independent hardware vendor (IHV) supplied graphics driver 190 is allowed execute. Conversely, trusted OS 180 executes within ring-zero execution environment 280. At process block 450, virtual addresses referenced by one are more trusted application commands or translated into addresses within the protected physical pages assigned to the trusted application. Accordingly, in one embodiment, the assignment of a unique trusted GTT to a trusted graphics application provides a protected execution environment for the trusted graphics application, which is inaccessible to other graphics applications or rogue agents.

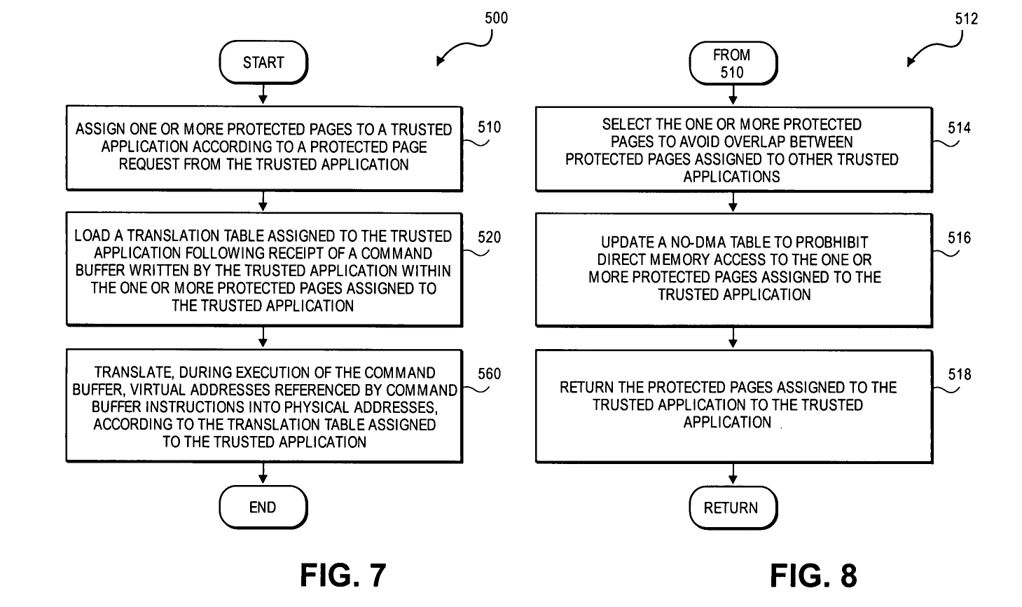

FIG. 7 is a flowchart illustrating a method 500 for executing a command buffer written by a trusted graphics application, in accordance with one embodiment. At process block 510, one or more protected pages are assigned to a trusted application according to a received protected page request from the trusted application. In one embodiment, assignment of the protected pages is performed by the trusted OS. At process block 520, a translation table assigned to the trusted application is loaded following receipt of the command buffer written by the trusted application.

In one embodiment, the command buffer is written within the one or more protected pages assigned to the trusted application. At process block 560, during execution of the command buffer, virtual addresses referenced by command buffer instructions are translated into physical addresses according to the translation table assigned to the trusted application. In one embodiment, the command buffer is used to permit video display software control of the parameters provided to motion picture expert group (MPEG) acceleration commands or other like video acceleration commands.

FIG. 8 is a flowchart illustrating a method 512 for assigning the one or more protected pages to the trusted application. At process block 514, the one or more protected pages are selected to avoid overlap between protected pages assigned to other trusted applications, as well as pages assigned to non-trusted applications. At process block 516, a no-DMA table is updated to prohibit DMA to the assigned protected pages. At process block 518, the assigned protected pages are returned to the trusted application. In one embodiment, rendering commands are written into the assigned protected pages. In one embodiment, addresses associated with instructions that access surfaces (textures, frame buffers) fall within the virtual address space assigned to the trusted application.

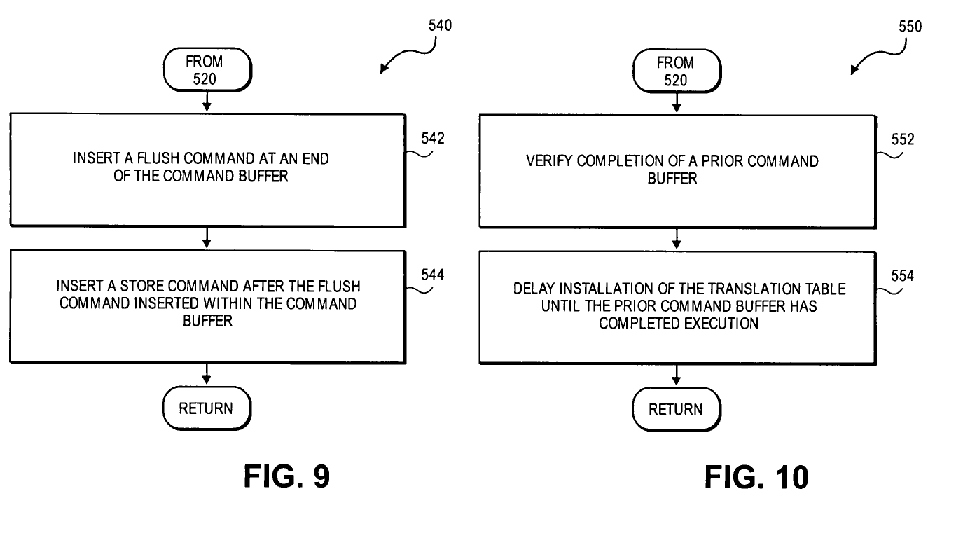

FIG. 9 is a flowchart illustrating a method 540, which is performed following generation of a command buffer, in accordance with one embodiment. In one embodiment, once the driver writes out the rendering command to complete the command buffer, the protected pages, which contain the command buffer and the size of the populated command buffer, are provided to the trusted OS. However, prior to providing the command buffer pages to the trusted OS, at process block 542, the driver inserts a flush command at the end of the command buffer. Subsequently, at process block 544, the driver inserts a store command within the command buffer. In one embodiment, each command buffer is terminated by a pipeline flush command and a store dword command.

FIG. 10 is a flowchart illustrating a method 550 for loading the translation table assigned to the trusted application of process block 520 of FIG. 8, in accordance with one embodiment. Accordingly, in one embodiment, the trusted OS is responsible for mapping the virtual address space referenced by command buffer commands into actual physical pages. As described above, this is performed by assigning each application a unique GTT. In one embodiment, the trusted OS is responsible for copying in the correct GTT within the privileged execution level before the command buffer begins execution. Accordingly, in one embodiment, at process block 552, the trusted OS verifies completion of a prior command buffer before loading of the GTT associated with the command buffer.

Hence, in one embodiment, in order to enable secure behavior, the trusted OS is responsible for swapping out the previous application's GTT only after the previously executing command buffer has finished execution. Otherwise, unsynchronized swapping will cause an application to use another application's GTT, thus gaining access to another application's memory space to prohibit the protected execution of trusted graphics applications. Accordingly, at process block 545, the trusted OS delays installation of the translation table until the prior command buffer has completed execution.

In one embodiment, command buffer completion indication is obtained by waiting for a store command to take affect to indicate command buffer completion. However, a rogue application may try to fool the trusted OS into swapping the GTT earlier by issuing an early store command into the ring-zero execution environment. In one embodiment, this situation is avoided by requiring that the trusted OS ensure that the complete command buffer is executed by verifying that the command buffer head and tail coincide and the store command has taken effect prior to inserting the new GTT. In one embodiment, head and tail equality can be verified by either reading a command buffer register (see Table 2) or issuing a report head instruction in the ring buffer before the final store command.

Accordingly, in one embodiment, each command buffer is terminated by a pipeline flush and store command. Hence, in one embodiment, the trusted OS ends a new command buffer with a flush (optionally report head) and store command. Accordingly, prior to activating a new command buffer, the trusted OS waits for the store command of the currently executing command buffer to take effect. Subsequently, the trusted OS verifies current completion of the command buffer by reading the command buffer head and tail register or examining the report head contents (see Table 2). When both store command and head tail equality have been verified, the trusted OS places a new GTT within the execution ring and then programs the command buffer register to activate the new buffer (see FIG. 4).

Accordingly, by assigning each trusted application its own unique trusted GTT, each application is prohibited from generating an access into another trusted application's graphics address space. Accordingly, by using its own trusted GTT, a trusted graphics application can maintain data integrity. Accordingly, address space isolation is maintained by using or performing the assignment of a unique GTT to each trusted application in order to provide address space isolation for graphics adapters. Accordingly, by assigning a unique GTT to each application, rogue drivers are prohibited from generating access to an address space that is outside their assigned address space, thereby providing a secure execution environment for trusted graphics applications.

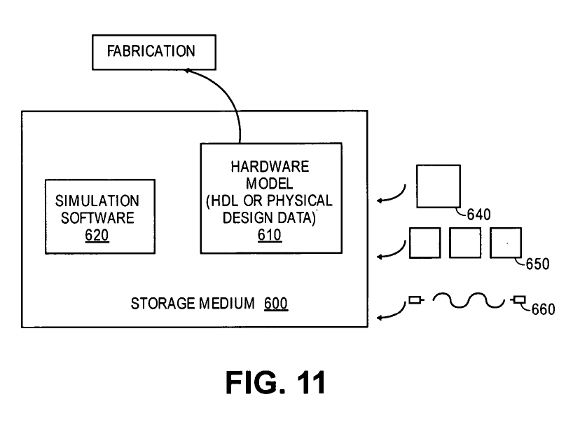

FIG. 11 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 610 may be stored in a storage medium 600, such as a computer memory, so that the model may be simulated using simulation software 620 that applies a particular test suite 630 to the hardware model to determine if it indeed functions as intended. In some embodiments, the simulation software is not recorded, captured or contained in the medium.

Additionally, a circuit level model with logic and/or transistor gates may be produced at some stages of the design process. The model may be similarly simulated some times by dedicated hardware simulators that form the model using programmable logic. This type of simulation taken a degree further may be an emulation technique. In any case, reconfigurable hardware is another embodiment that may involve a machine readable medium storing a model employing the disclosed techniques.

Furthermore, most designs at some stage reach a level of data representing the physical placements of various devices in the hardware model. In the case where conventional semiconductor fabrication techniques are used, the data representing the hardware model may be data specifying the presence or absence of various features on different mask layers or masks used to produce the integrated circuit. Again, this data representing the integrated circuit embodies the techniques disclosed in that the circuitry logic and the data can be simulated or fabricated to perform these techniques.

In any representation of the design, the data may be stored in any form of a machine readable medium. An optical or electrical wave 660 modulated or otherwise generated to transport such information, a memory 650 or a magnetic or optical storage 640, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

Alternate Embodiments

It will be appreciated that, for other embodiments, a different system configuration may be used. For example, while the system 100 includes an integrated GMCH, for other embodiments, a separate graphics chipset may benefit from the secure execution of graphics applications of various embodiments. Further different type of system or different type of computer system such as, for example, a server, a workstation, a desktop computer system, a gaming system, an embedded computer system, a blade server, etc., may be used for other embodiments.

Having disclosed exemplary embodiments and the best mode, modifications and variations may be made to the disclosed embodiments while remaining within the scope of the embodiments of the invention as defined by the following claims.

1. A method comprising:
assigning one or more protected pages to a trusted application according to a protected page request from the trusted application;
loading a translation table assigned to the trusted application following receipt of a command buffer written by the trusted application within the one or more protected pages assigned to the trusted application; and
translating, during execution of the command buffer, virtual addresses referenced by command buffer instructions into physical addresses, according to the translation table assigned to the trusted application.

2. The method of claim 1, wherein allocating the one or more protected pages comprises:
selecting the one or more protected pages to avoid overlap between protected pages assigned to other trusted applications;
updating a no-DMA table to prohibit direct memory access to the one or more protected pages assigned to the trusted application; and
returning the protected pages assigned to the trusted application to the trusted application.

3. The method of claim 1, wherein prior to translating, the method further comprises:
inserting a flush command at an end of the command buffer; and
inserting a store command after the flush command inserted within the command buffer.

4. The method of claim 1, wherein prior to assigning the one or more protected pages, the method comprises:
assigning a virtual address space to the trusted application; and
generating a translation table to map the virtual address space assigned to the trusted application to a physical address space within one or more protected pages to the trusted application.

5. The method of claim 1, wherein loading comprises:
(a) verifying completion of a prior command buffer; and
(b) delaying installation of the translation table until the prior command buffer has completed execution, as determined in (a).

6. A method comprising:
forming a unique translation table for a trusted application according to one or more protected physical pages assigned to the trusted application; and
translating a virtual address space of the trusted application to a physical address space within the one or more protected pages according to the translation table.

7. The method of claim 6, wherein forming the unique translation table comprises:
receiving a request for assignment of one or more protected pages to the trusted application;
assigning the one or more protected pages from physical memory to avoid overlap between protected pages assigned to other trusted applications;
assigning a virtual address space to the trusted application; and
generating the translation table to map the virtual address space assigned to the trusted application to the physical address space within the protected pages.

8. The method of claim 6, wherein prior to forming, the method comprises:
(a) detecting launch of an application;
(b) authenticating the detected application; and
(c) identifying the detected application as the trusted application if authentication, as determined in (b) is successful.

9. The method of claim 6, wherein forming further comprises:
restricting access to the one or more protected pages assigned to the trusted application; and
restricting access to the unique translation table.

10. The method of claim 9, wherein restricting access to the one or more protected pages comprises:
updating an no-DMA table to prohibit direct memory access to the one or more protected pages assigned to the trusted application.

11. The method of claim 6, wherein translating comprises:
loading, prior to execution of the trusted application, the translation table assigned to the trusted application; and
mapping virtual addresses referenced by one or more trusted application commands into physical addresses within the protected physical pages assigned to the trusted application.

12. The method of claim 6, wherein translating further comprises:
identifying a command buffer including command instructions written by the trusted application;
loading the translation table assigned to the trusted application within a secure execution area; and
mapping, during execution of the command buffer, virtual addresses referenced by the command instructions into physical addresses according to the translation table assigned to the trusted application.

13. The method of claim 6, wherein loading comprises:
(a) verifying completion of a prior command buffer; and
(b) delaying installation of the translation table until the prior command buffer has completed execution as determined in (a).

14. The method of claim 13, wherein verifying completion comprises:
verifying that a command buffer head pointer and tail pointer are equal; and
verifying that a store command at the end of the prior command buffer has taken affect prior to installation of the translation table.

15. The method of claim 12, wherein prior to mapping, the method further comprises:
inserting a flush command at and end of the command buffer; and
inserting a store command after the flush command within the command buffer.

16. An article of manufacture including a machine readable medium having stored thereon instructions which may be used to program a system to perform a method, comprising:
forming a unique translation table for a trusted application according to one or more protected physical pages assigned to the trusted application;
loading, prior to execution of the trusted application, the translation table assigned to the trusted application; and
translating a virtual address space of the trusted application to a physical address space within the one or more protected pages according to the translation table.

17. The article of manufacture of claim 16, wherein forming the unique translation table comprises:
receiving a request for assignment of one or more protected pages to the trusted application;
selecting the one or more protected pages from physical memory to avoid overlap between protected pages assigned to other trusted applications;
assigning a virtual address space to the trusted application; and
generating the translation table to map the virtual address space assigned to the trusted application to the physical address space within the protected pages.

18. The article of manufacture of claim 16, wherein translating comprises:
mapping virtual addresses referenced by one or more trusted application commands into physical addresses within the protected physical pages assigned to the trusted application.

19. The article of manufacture of claim 16, wherein loading comprises:
(a) verifying completion of a prior command buffer; and
(b) delaying installation of the translation table until the prior command buffer has completed execution as determined in (a).

20. The article of manufacture of claim 19, wherein verifying completion comprises:
verifying that a command buffer head pointer and tail pointer are equal; and
verifying that a store command at the end of the prior command buffer has taken affect prior to installation of the translation table.

21. An apparatus, comprising:
a controller to load a unique translation table for a trusted application according to one or more protected physical pages assigned to the trusted application and to translate a virtual address space of the trusted application to a physical address space within the one or more protected pages according to the translation table.

22. The apparatus of claim 21, further comprising:
a memory coupled to the controller, the memory to store a trusted operating system portion, the trusted operating system portion to form the unique translation table for the trusted application according to one or more protected physical pages assigned to the trusted application.

23. The apparatus of claim 22, wherein the controller further comprises:
a graphics engine to execute one or more command buffer instructions within a command buffer written by a trusted graphics application, the controller to load a translation table assigned to the trusted graphics application and to translate, during execution of the command buffer instructions, virtual addresses referenced by the command buffer instructions into physical addresses, according to the translation table assigned to the trusted graphics application.

24. The apparatus of claim 22, wherein the graphics engine is one of a display engine and a render engine.

25. The apparatus of claim 22, wherein the trusted operating system partition is to receive a request for assignment of one or more protected pages to the trusted application, to assign the one or more protected pages from physical memory to avoid overlap between protected pages assigned to other trusted applications, to assign a virtual address space to the trusted application and to generate the translation table to map the virtual address space assigned to the trusted application to the physical address space within the protected pages.

26. A system comprising:
a memory, the memory to store a trusted operating system portion, the trusted operating system portion to form a unique translation table for a trusted graphics application according to one or more protected physical pages assigned to the trusted graphics application; and
a chipset coupled to the memory, the chipset including a graphics controller to load a translation table assigned to the trusted graphics application following receipt of a one or more command buffer instructions within a command buffer written by the trusted graphics application within the one or more protected pages assigned to the trusted graphics application, and to translate, during execution of the command buffer, virtual addresses referenced by command buffer instructions into physical addresses, according to the translation graphics table assigned to the trusted graphics application.

27. The system of claim 26, wherein the chipset comprises:
a memory controller coupled between the memory and the graphics controller.

28. The system of claim 26, wherein the chipset comprises:
an integrated graphics memory controller hub.

29. The system of claim 26, further comprising:
a display coupled to the graphics controller.

30. The system of claim 26, further comprising:
a volatile memory coupled to the graphics controller.
